(19) United States
(12) Patent Application Publication
(10) Pub. No.: US 2002/0050218 A1
(43) Pub. Date: May 2, 2002

(54) Process for creating a printing form for a printing prese

(76) Inventor: Arndt Jentzsch, Coswig (DE)

Correspondence Address: GABRIEL P. KATONA, GOODWIN PROCTER L.L.P., 599 LEXINGTON AVENUE, 40TH FLOOR, NEW YORK, NY, 10022, US

(21) Appl. No.: 09/924,161

(22) Filed: Aug. 7, 2001

(30) Foreign Application Priority Data
Aug. 9, 2000 (DE) 100 39 819.9

(51) Int. Cl. B41C 1/00; B41N 6/00

(52) U.S. Cl. 101/401.1

(57) ABSTRACT

The invention relates to a process for creating an image carrying printing form on a printing form cylinder in a printing press.

Task of the invention is to realize a process for creating an erasable printing form on a printing form cylinder in a printing press with low expenditures and high life time.

The task is solved according the invention by the printing cylinder having an oxidable surface and the oxidable surface being image carrying oxidized. The so created printing form is used for printing. The oxidized surface is reconverted by a reduction after printing.

### FIELD OF INVENTION

The invention relates to a process for creating an image carrying printing form on a printing form cylinder in a printing press.

### BACKGROUND OF INVENTION

A process for creating a printing form for offset printing presses, especially for presses with a dampening unit, with water repelling ink receptive image areas and water receptive, the affinity to water influencing areas are known by DE 4119111 A1. An oil receptive water resistant coating medium is created in dots or matrixes by small droplets from at least one nozzle connected to a reservoir and applied on parts of the water receptive surface of a printing form cylinder. The nozzle is moved in line direction and perpendicular to the printing form cylinder. A central control unit receives digital image information from an information storage and transmits the control signals through a transfer unit and a control unit to the nozzle and the printing form cylinder.

Furthermore the Xerox copy process is well known. This copy process creates a latent image on a semiconductor cylinder. This image is transferred with a powdered toner to the paper sheet and the latent image is erased. This process can not be used in printing presses.

### SUMMARY DESCRIPTION OF INVENTION

Task of the invention is to realize a process for creating an erasable printing form on a printing form cylinder in a printing press with low expenditures and high life time.

The task is solved according the invention by the printing cylinder having an oxidable surface and the oxidable surface being image carrying oxidized. The so created printing form is used for printing. The oxidized surface is reconverted by a reduction after printing.

### BRIEF DESCRIPTION OF THE DRAWING

The invention is described below in greater detail by an embodiment of the invention, by reference being had to the drawing, wherein:

FIG. 1: Printing form cylinder with reduction device

FIG. 2: Printing form cylinder with oxidation device

### DETAILED DESCRIPTION

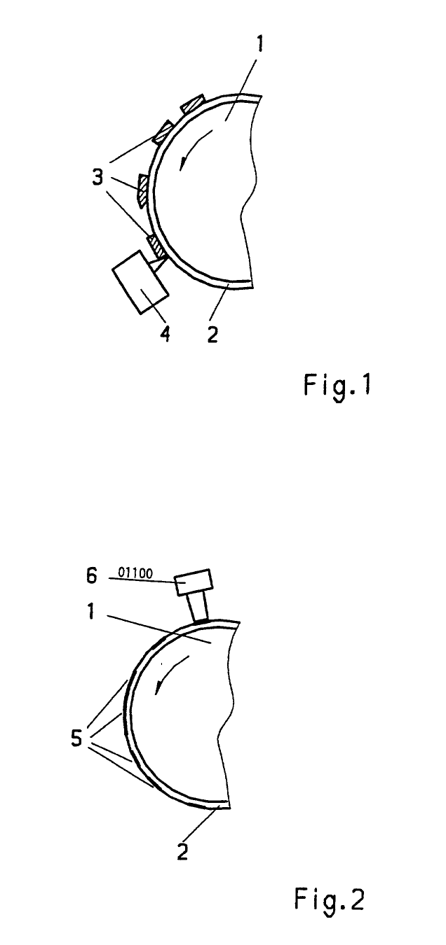

FIG. 1 shows a printing form cylinder in a printing press. The printing form cylinder 1 has an oxidable surface 2 appropriately with water receptive characteristic.

The oxidable surface 2 has image carrying oxidized areas 3 from the preceding printing job. These areas are water repelling.

Before new image carrying areas 1 can be applied to the printing form cylinder 1 the image carrying oxidized areas 3 of the preceding printing job must be erased. This image carrying oxidized areas 3 of the preceding printing job are erased by an reduction device 4 allocated to the printing form cylinder 1. The reduction device 4 operates with the laser principle. It traverses over the width of the printing form cylinder 1 or stretches over the entire width of the printing form cylinder 1.

The reduction is an endothermic reaction, which withdraws oxygen from a chemical compound. It means the metal ions get their valence electrons and with it their metal characteristic back.

FIG. 2 shows the process step oxidation of the new image carrying areas of the oxidable surface 2. The new image carrying areas of the new printing job are oxidized with the oxidation device 6.

The oxidation is an exothermic reaction with oxygen whereby the valence electrons are released and the metal characteristic is lost. It means the oxidized areas 5 are made receptive for the latter applied printing ink.

The oxidation device 6 has a not shown storage device for digital matrix of the image carrying areas. The oxidation device 6 traverses like the reduction device 4 or stretches over the entire width of the printing form cylinder 1.

We claim:

1. Process for creating an image carrying printing form on a printing form cylinder in a printing press whereby
the printing form cylinder has a oxidable surface
the oxidizable surface is image carrying oxidized
the created printing form is used for printing and
the oxidized surface is reconverted in an oxidable surface by reduction.

2. Process for creating an image carrying printing form on a printing form cylinder in a printing press according to claim 1
whereby oxygen or a medium releasing oxygen under energy input is supplied to the oxidable object during oxidation.

3. Process for creating an image carrying printing form on a printing form cylinder in a printing press according to claim 1
whereby a medium taking oxygen under energy input is supplied to the reduced object during reduction.
